(19) United States
(12) Patent Application Publication
(10) Pub. No.: US 2014/0191595 A1
(43) Pub. Date: Jul. 10, 2014

(54) Device and Control System for Producing Electrical Power

(71) Applicants: Stephen Miles, Palm City, FL (US); Michael Cristoforo, Palm City, FL (US)

(72) Inventors: Stephen Miles, Palm City, FL (US); Michael Cristoforo, Palm City, FL (US)

(21) Appl. No.: 14/147,353

(22) Filed: Jan. 3, 2014

Related U.S. Application Data
(60) Provisional application No. 61/748,974, filed on Jan. 4, 2013.

(51) Int. Cl. H02K 35/02; H02K 7/075

(52) U.S. Cl. CPC H02K 35/02; H02K 7/075
USPC 310/15; 310/20

(57) ABSTRACT

Briefly, the invention involves a system and method for generating electrical power. The system includes an electromagnet positioned with one pole directed toward a like pole of a permanent magnet. The permanent magnet is preferably mounted for oscillating movement toward the pole of the electromagnet. A control system for the electromagnet is provided to supply direct current (DC) power in the form of square wave pulses which coincide with the position of the permanent magnet. Power is collected upon the collapse of the magnetic field within the electromagnetic magnet. In some embodiments the present device is supplied in the form of a reciprocating engine which provides rotary motion in addition to the electrical power generated.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. provisional patent application No. 61/748,974, filed Jan. 4, 2013, entitled “Device and Control System for Producing Electrical Power”, which claims priority as a continuation-in-part to U.S. patent application Ser. No. 13/454,839, filed Apr. 24, 2012, entitled, “Magnetically Powered Reciprocating Engine And Electromagnet Control System”, which issued May 21, 2013 to U.S. Pat. No. 8,446,112, which is a continuation of U.S. patent application Ser. No. 12/701,781, filed Feb. 8, 2010, entitled, “Magnetically Powered Reciprocating Engine And Electromagnet Control System”, which issued May 29, 2012 to U.S. Pat. No. 8,188,690. The contents of each of the above referenced applications are herein incorporated by reference in its entirety.

### FIELD OF THE INVENTION

The present invention generally relates to power generation and more particularly to a device for generating electrical power in either a static or dynamic configuration.

### BACKGROUND INFORMATION

Electricity generation is the process of generating electric power from sources of kinetic and potential energy. In general, there are seven fundamental methods of directly transforming other forms of energy into electrical energy.

For example, static electricity was the first form discovered and investigated. In general, static electricity is an excess of an electrical charge trapped on the surface of an object. A static electricity charge is created when two objects are rubbed together and at least one of the surfaces has a high resistance to electrical current. Since materials are all constructed from atoms, and atoms are constructed from protons in their nuclei and electrons in their shells, static electricity requires the electrons to move from one object to the other while in contact. When the objects are then separated the charge imbalance remains. The charge imbalance can be discharged from either object by connecting, or placing the object, in suitable proximity to a ground. While static electricity was the first type discovered and investigated it has found very few commercial uses other than Van de Graaff and magnetohydrodynamic (MHD) generators.

Electrochemistry, involving the direct transformation of chemical energy into electricity, has found important uses mostly in portable and mobile applications. Currently, most electrochemical power comes from closed electrochemical cells, e.g. batteries, which are generally utilized more for storage than for power generation. However, open electrochemical systems, e.g. fuel cells, have been the subject of a great deal of research and development. Fuel cells can be used to extract electrical power from natural or synthetic fuels which may include alcohol or gasoline. However, electrolytic hydrogen has been the primary fuel of recent technological advances.

Photoelectric involves the transformation of light into electrical energy, e.g. solar cells. Photovoltaic panels convert sunlight directly to electricity. Although sunlight is free and abundant, solar electricity is still usually more expensive to produce than large-scale mechanically generated power due to the cost of the panels. Until recently, photovoltaics were most commonly used in remote sites where there is no access to a commercial power grid or as a supplemental electricity source for individual homes and businesses.

Thermoelectric involves the direct conversion of temperature differences into electricity. Current devices include thermocouples, thermopiles and thermionic converters. A thermoelectric device creates a voltage when there is a different temperature on opposite sides or ends of a piece of material. At the atomic scale, an applied temperature gradient causes charge carriers in the material to diffuse from the hot side of the material to the cold side. This effect can be used to generate electricity, measure temperature or change the temperature of objects. Because the direction of the heating and cooling is determined by the polarity of the applied voltage, thermoelectric devices are often utilized as temperature controllers.

Piezoelectric develops electricity from the mechanical strain of electrically anisotropic molecules or crystals. The piezoelectric state is understood as the linear electromechanical interaction between the mechanical and the electrical state in crystalline materials with no inversion symmetry. The piezoelectric effect is a reversible process in that materials exhibiting a direct piezoelectric effect, also exhibit the reverse piezoelectric effect upon the application of an electrical field. Piezoelectricity is found in a number of applications such as the production and detection of sound, generation of high voltages, electronic frequency generation, microbalances and ultrafine focusing of optical assemblies.

Nuclear transformation involves the creation and acceleration of charged particles. Examples include betavoltaics and alpha particle emission. Betavoltaics are, in effect, a form of battery which uses energy from a radioactive source emitting beta particles, e.g. electrons. Unlike most nuclear power sources which use nuclear radiation to generate heat, which is then used to rotate a turbine, betavoltaics use a non-thermal conversion process; converting the electron-hole pairs produced by the ionization trail of beta particles traversing a semiconductor. The primary use for betavoltaics is for remote long term uses requiring low voltage.

Electromagnetic induction transforms kinetic energy into electricity. Electromagnetic induction produces electric current across a conductor moving through a magnetic field. It underlies the operation of generators, transformers, induction motors, synchronous motors, and solenoids. This is the most used form of electrical power generation and is based on Faraday's law. Faraday formulated that electromotive force (EMF) produced around a closed path is proportional to the rate of change of the magnetic flux through any surface bounded by that path. In practice, this means that an electric current will be induced in any closed circuit when the magnetic flux through a surface bounded by the conductor changes. Almost all commercial electrical generation is done using electromagnetic induction, in which mechanical energy is utilized to rotate an electrical generator. There are numerous ways of developing the mechanical power including heat engines, hydro, wind and tidal power.

While these devices and systems have met with success in several industries and scientists, the prior art has failed to meet the needs and expectations of the public at large. Electrical power is generally very expensive to produce and distribute and is replete with harmful environmental impacts. For example, the amount of water usage is of great concern for electrical generation systems, especially as populations and therefore demands continue to increase. Steam cycle electrical plants require a great deal of water for cooling. In addition, most electricity today is generated using fossil fuels. The fossil fuel is burned to produce steam which is used to turn a steam turbine. Alternatively, the fossil fuel is used to operate an internal combustion or heat cycle engine. The engine is then used to rotate the turbine. Fossil fuel supplies are finite and emissions to the atmosphere from burning the fossil fuel are significant. The estimated CO2 emission from the world's electrical power industry is estimated at 10 billion tons yearly. The carbon dioxide contributes to the greenhouse effect, and thus to global warming. Depending on the particular fuel being burned, other emissions may be produced as well. Ozone, sulfur dioxide, NO2, as well as particulate matter are often released into the atmosphere. Still yet, heavy elements such as mercury, arsenic and radioactive materials are also emitted.

Thus, the present invention provides a new device and system for generating electrical power which overcomes the disadvantages of prior art electrical generation systems. The generation system of the present invention not only provides for relative portability, it also permits power generation without the need of fossil fuels. In some embodiments, the present invention also provides rotary motion which may be utilized to rotate additional generators, alternators, machinery, or provide propulsion to automobiles or the like.

### SUMMARY OF THE INVENTION

Briefly, the invention involves a system and method for generating electrical power. The system includes an electromagnet positioned with one pole directed toward a like pole of a permanent magnet. The permanent magnet is preferably mounted for oscillating movement toward the pole of the electromagnet. A control system for the electromagnet is provided to supply direct current (DC) power in the form of square wave pulses which coincide with the position of the permanent magnet. Power is collected upon the collapse of the magnetic field within the electromagnetic magnet. In some embodiments, the present device is supplied in the form of a reciprocating engine which provides rotary motion in addition to the electrical power generated.

Accordingly, it is an objective of the present invention to provide an electrical power generation device.

It is a further objective of the present invention to provide a method of generating electrical power.

It is yet a further objective of the present invention to provide a power generation system that utilizes certain aspects of thermo electric power generation to aid in the development of electrical power.

It is another objective of the instant invention to provide a power generation system that utilizes a highly polarized permanent magnet placed in close proximity to a metallic magnon gain medium (MMGM) and a control system for supplying energy pulses to the MMGM and electromagnet in the form of EMF.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a top view partially in section illustrating one embodiment of the present invention;

FIG. 2 is a top view of an alternative embodiment of the present invention;

FIG. 3 is a side view of an alternative embodiment of the present invention;

FIG. 4 is a perspective view illustrating one embodiment of a coil assembly of the present invention;

FIG. 5 is an electrical schematic of one embodiment of the present invention;

FIG. 6 is a partial view of the schematic illustrated in FIG. 5;

FIG. 7 is a partial view of the schematic illustrated in FIG. 5;

FIG. 8 is a partial view of the schematic illustrated in FIG. 5;

FIG. 9 is a partial view of the schematic illustrated in FIG. 5;

FIG. 10 is a partial view of the schematic illustrated in FIG. 5;

FIG. 11 is a partial view of the schematic illustrated in FIG. 5;

FIG. 12 is an electrical schematic of a power control circuit of one embodiment of the present invention;

FIG. 13 illustrates one embodiment of the power delivery to the electromagnetic coils when the power control circuit of FIG. 12 is utilized; and

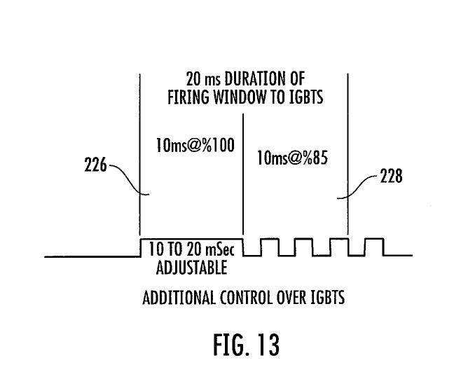

FIG. 14 illustrates a portion of a dynamometer test conducted on the system illustrated in FIG. 1.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

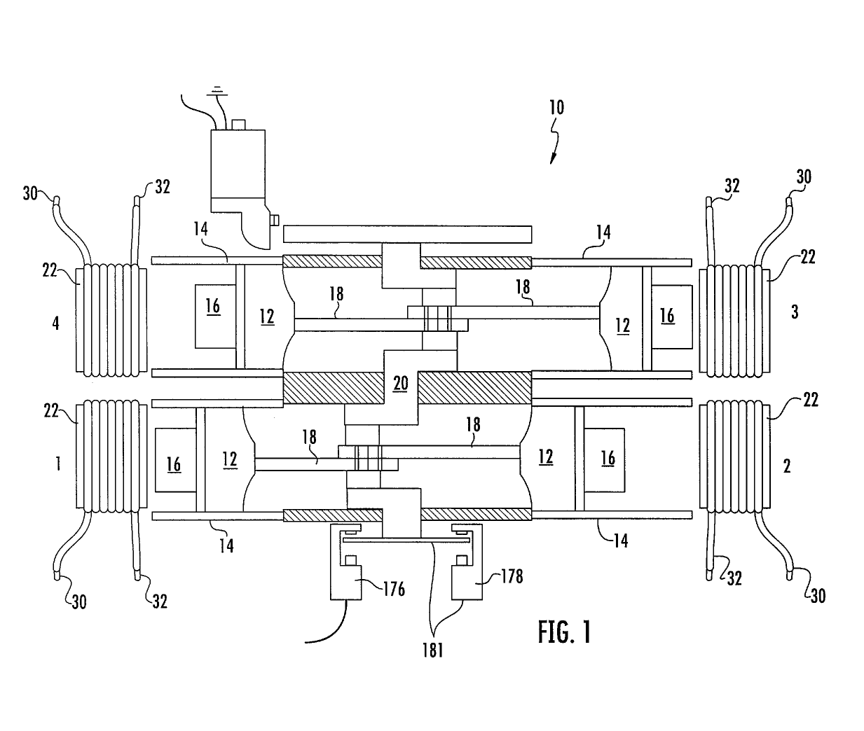

Referring to FIG. 1, one embodiment of the present power generation system is illustrated in the form of a magnetically operated reciprocating engine 10. The magnetically operated reciprocating engine 10 includes at least one piston 12 constructed and arranged to reciprocate along a substantially linear path illustrated herein as a cylinder 14. The piston 12 includes at least one, and preferably a plurality of permanent magnets 16 secured thereto. The magnets are preferably secured to a top surface of the piston 12 via a non-metallic member or assembly. The piston 12 is pivotally secured to a connecting rod 18 that is rotationally connected to a crankshaft 20 to convert the reciprocating movement of the piston into rotary motion at the crankshaft. An electromagnet assembly 22 is secured beyond the end of the piston 12 stroke at a position to react with the permanent piston magnets 16 when energized in a controlled manner. A timing/firing system 100 is utilized to monitor rotation of the crankshaft for causing the electromagnet assembly 22 to generate a magnetic field in response to crankshaft position. The electromagnet assembly 22 and permanent magnets 16 are preferably configured so that a pushing force is created between the coil banks and the pistons. In an alternative embodiment one bank may be electromagnetically pushing while the opposite bank is electromagnetically pulling. It should be noted that while a horizontally opposed engine is illustrated, the instant invention can be utilized on any reciprocating engine configuration known in the art without departing from the scope of the invention. Such engine configurations include, but should not be limited to, V-configurations, W-configurations, in line configurations, radial configurations and the like.

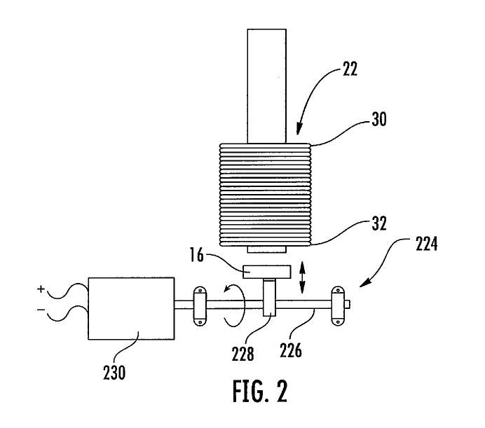

Referring to FIG. 2, an alternative embodiment of the present invention is illustrated. In this embodiment, the power generation system includes at least one permanent magnet 16 constructed and arranged to reciprocate or oscillate along a substantially linear path. The at least one magnet 16 may be guided by a cylinder, partial cylinder, rail or any other means known in the art for guiding mechanical assemblies. A cam assembly 224 is secured behind the permanent magnet 16 for moving the permanent magnet in a reciprocating motion. The cam assembly 224 preferably includes a camshaft 226 having at least one eccentric lobe 228 and a motor 230 for rotating the camshaft. The at least one magnet may include springs, gas cylinders or the like (not shown) to maintain contact between the camshaft lobe and the permanent magnet. In this manner, the magnet will reciprocate back and forth with rotation of the camshaft. An electromagnet assembly 22 is secured beyond the end of the stroke of the at least one permanent magnet at a position to react with the permanent magnets 16 when energized in a controlled manner. A timing/firing system 100 is utilized to monitor rotation of the camshaft for causing the electromagnet assembly 22 to generate a magnetic field in response to camshaft position. The electromagnet assembly 22 and permanent magnets 16 are preferably configured so that a pushing force is created between the electromagnet assembly and the at least one permanent magnet. It should be appreciated that while only one permanent magnet, cam and electromagnet assembly are illustrated, the power generation device may include any number of assemblies which may operate independently or in combination with each other. It should also be appreciated, that while a cam and motor are illustrated other means of reciprocating the permanent magnet(s) may be substituted without departing from the scope of the invention. Such reciprocating means may include, but should not be limited to, solenoids, linear motors, pneumatics, hydraulics, diaphragms, springs, shape memory alloys and the like.

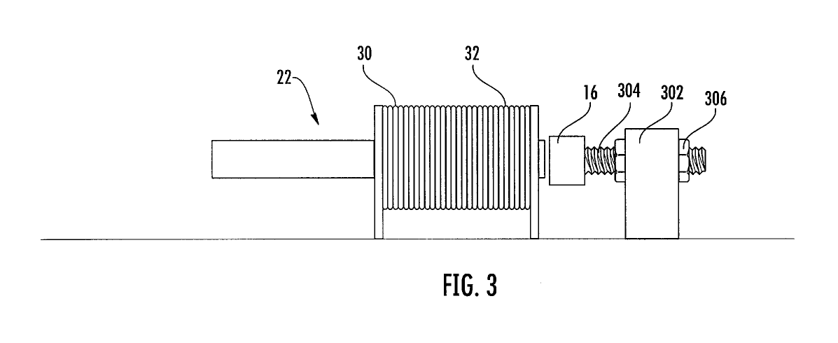

Referring to FIG. 3, another alternative embodiment of the present invention is illustrated. In this embodiment, the power generation system includes at least one permanent magnet in an adjustable yet fixed position with respect to the electromagnet assembly 22. The at least one permanent magnet 16 is preferably secured to an adjuster assembly 302. The adjuster assembly 302 is secured behind the permanent magnet 16 for allowing positional adjustment of the permanent magnet in a linear path toward or away from the electromagnet assembly. The adjuster assembly 302 preferably includes a threaded shaft 304 having at least one lock nut 306 for adjusting the position of the permanent magnet. A timing/firing system 100 is utilized for causing the electromagnet assembly 22 to generate a magnetic field. The electromagnet assembly 22 and permanent magnets 16 are preferably configured so that a pushing force is created between the electromagnet assembly and the at least one permanent magnet. In at least one embodiment, a device may be secured between the adjuster assembly and one of the magnets to cause the magnet to vibrate or oscillate in a controlled manner whereby the poles of the magnets interact with each other during the oscillations. One non-limiting device suitable for providing the oscillations would be a piezoelectric crystal or a combination of piezoelectric crystals. The piezoelectric crystal(s) may be stimulated by an electrical current to ultrasonic levels thereby moving the magnet at the same oscillation level. It should be appreciated that while only one permanent magnet and electromagnet assembly are illustrated, the power generation device may include any number of assemblies which may operate independently or in combination with each other.

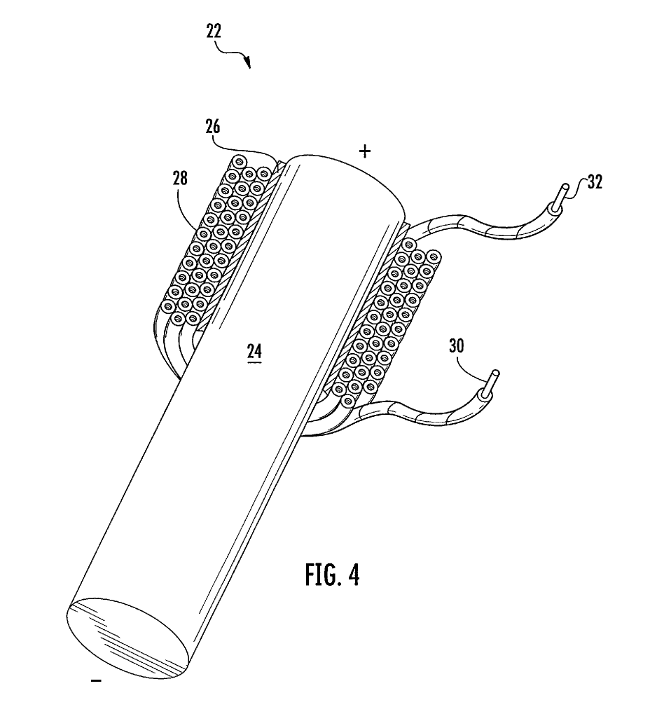

Referring to FIG. 4, a partial section view of an electromagnet assembly 22 suitable for use with the present invention is illustrated. The coil includes a central core 24 constructed of a ferromagnetic material suitable for creating a magnetic field. In a most preferred embodiment, the core is constructed of a material with high magnetic permeability and low coercivity and magnetostriction resulting in low hysteresis loss. In a most preferred embodiment, the core material is a cobalt-iron alloy approximately 50% cobalt and 50% iron. However, some alloys may contain about 49% cobalt, 49% iron with up to about 2% silicon, and trace amounts of manganese and/or niobium. Such material is sold under various trade names such as PERMENDUR, PERMENDUR 2V, HYPERCO 50, HYPERCO 50HS, and HYPERCO 50A. The core material should be annealed in a non-oxygen atmosphere to achieve large grain structure of the metal. In some embodiment, the core material may be magnetized prior to the anneal process. In other embodiments, the core material may be annealed within a magnetic environment. It should be noted that these materials while generally stable may be excited upon receiving an electrical or magnetic pulse at a natural frequency to enhance the production of electricity with the teachings of the present application. The Applicants have found various frequencies that significantly increase the production of electricity. One preferred frequency is about 10 kilohertz while an even more preferred frequency is about 37 kilohertz with a square wave form. Wrapped around the core is preferably a barrier layer 26 of DuPont KAPTON or some other well-known insulation. A plurality of wire wraps 28 extend around the core to create the electrical field. In the preferred non-limiting embodiment about 752 turns in 16 layers of 12 gauge copper wire wrapped in high heat polymer 28 insulation to form a coil 28. The distal ends 30 and 32 of the coil wire extend outwardly from the coil for attachment to the timing/firing system. It should be noted that providing more wraps of wire will provide a larger magnetic field when energized and less wraps will provide a smaller magnetic field as is known in the art. It should also be noted that in some embodiments the core includes a length that is about twice as long as the coil 28. In these embodiments, the coil is preferably positioned close to one distal end of the core with the remainder of the core extending outwardly from the coil.

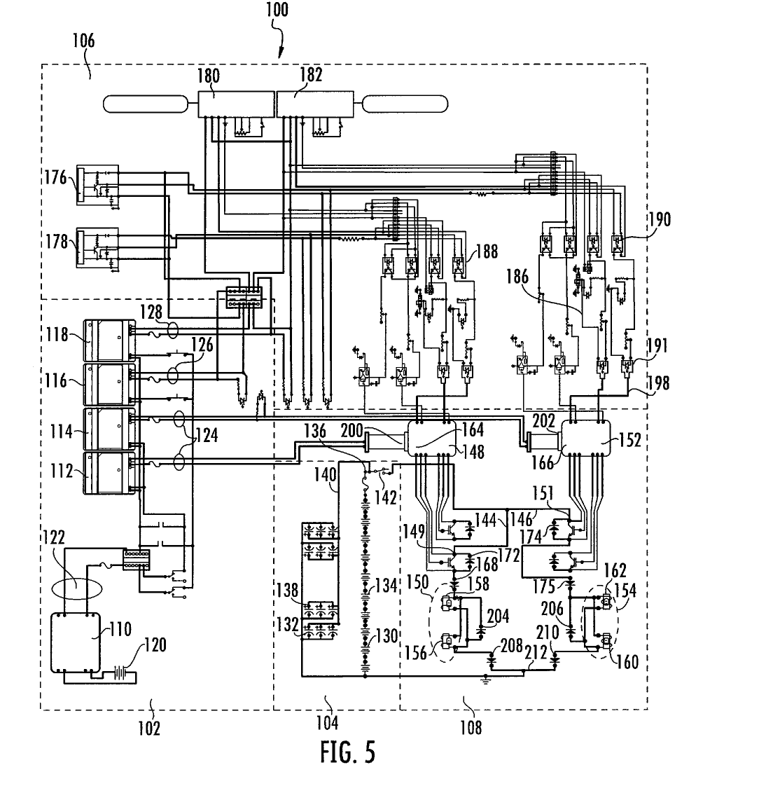

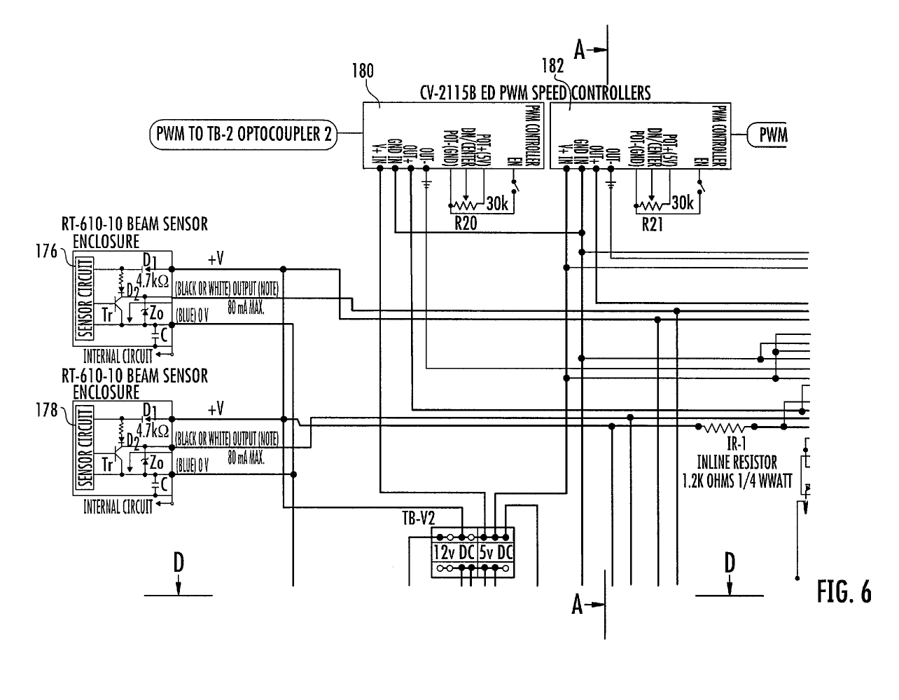

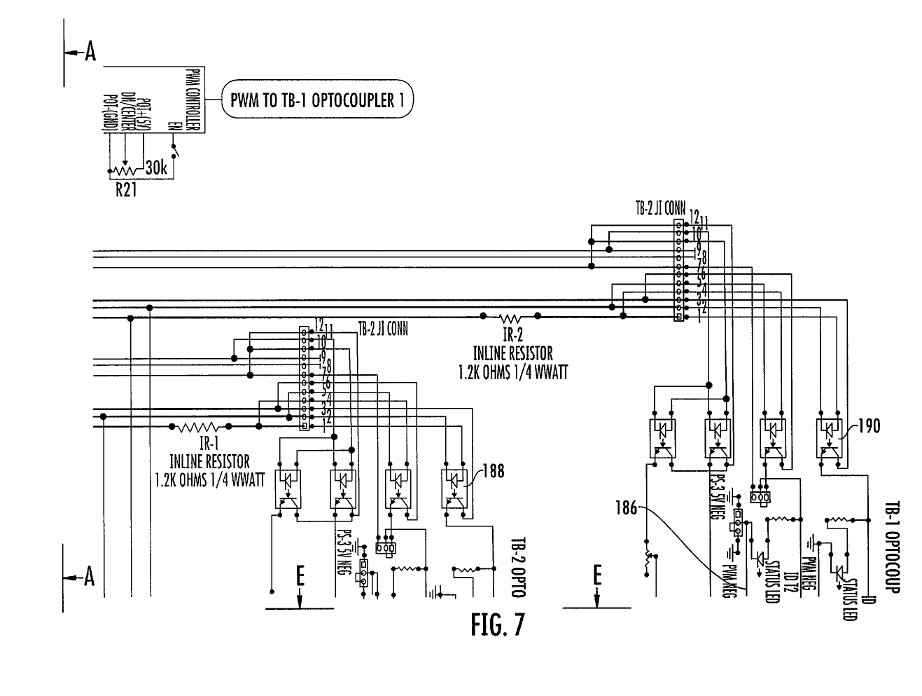

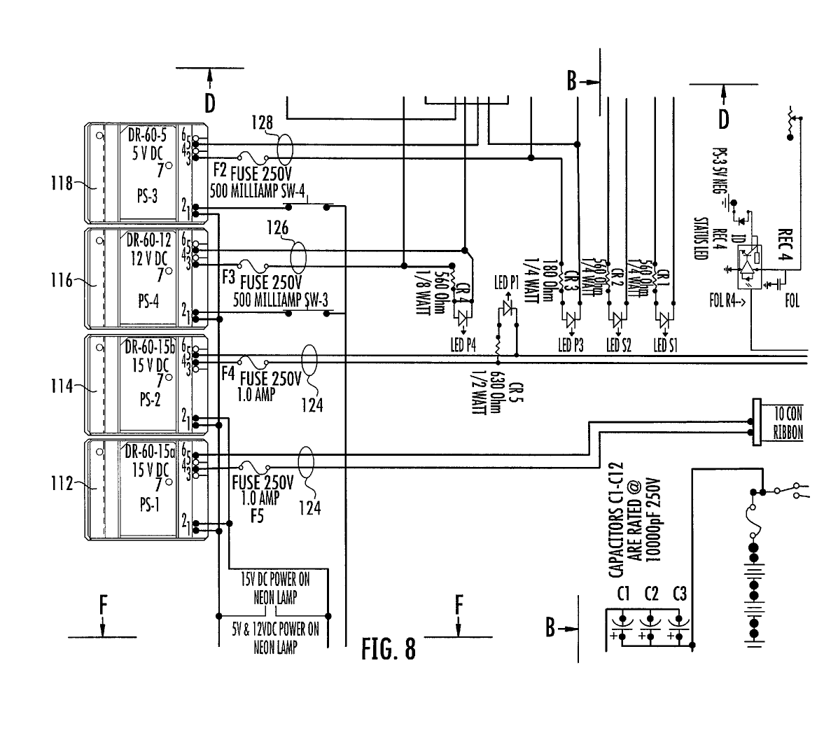

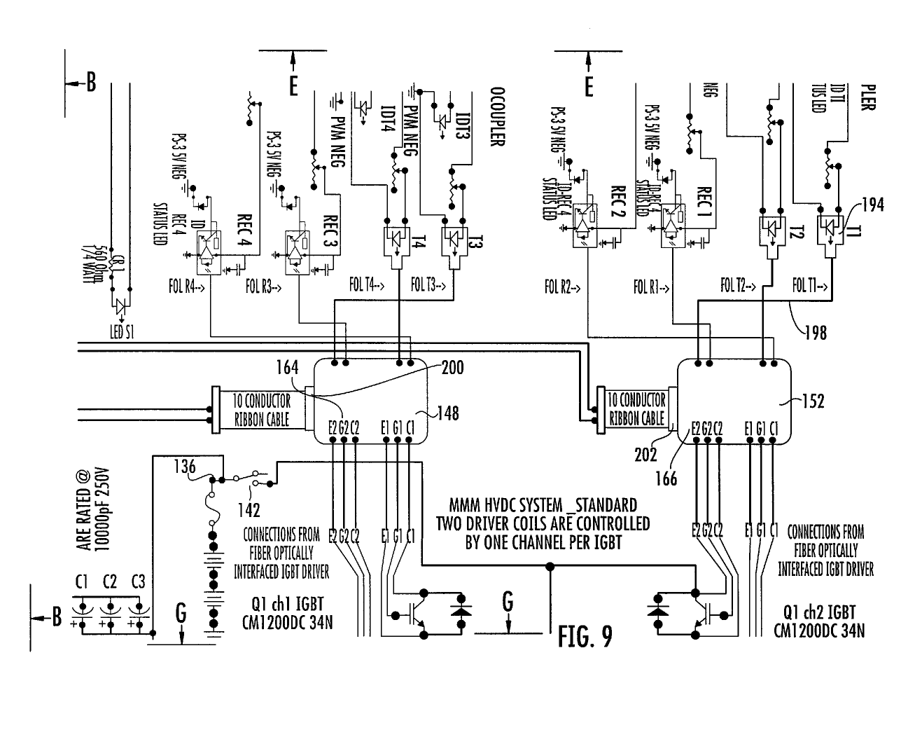

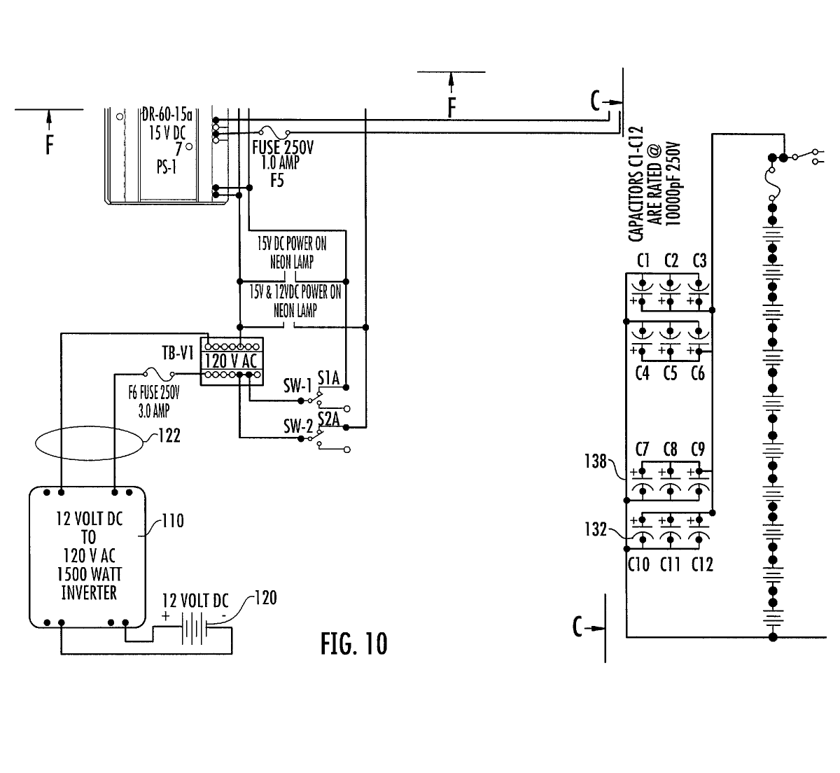

Referring to FIGS. 5-12, a wiring diagram showing one embodiment of the timing/firing system 100 is illustrated. It should be noted that the timing/firing system illustrated is for the embodiment illustrated in FIG. 1 having four electromagnetic coils, those skilled in the art will readily appreciate that the timing/firing system could be simplified for the embodiments illustrated in FIGS. 2 and 3. Those skilled in the art will also appreciate that additional coils could be added to the timing/firing circuit in the event that additional coils are utilized. The timing/firing system generally includes a low voltage power supply module 102, a high voltage supply module 104, a timing module 106, and a firing module 108. The low voltage power supply module 102 is comprised of a power inverter 110 and a plurality of power supplies 112, 114, 116, 118 having various output voltages for operation of the electronic components that make up the timing and firing modules 106, 108 respectively. The power inverter 110 preferably converts a 12V DC 120 supply of power to 120V AC 122, filtering and conditioning the 12V DC power to have a sine wave form. The converted power 122 is preferably supplied to four power supplies: a first 112 and a second 114 converting the 120V AC power 122 to 15V DC 124, a third 116 converting the 120V AC power to 12V DC 126, and a fourth 118 that converts 120V AC power to 5V DC 128. Because the high magnetic pulse flux that the timing/firing system is subject to can interfere with signaling and sensing functions, the inverter 110 and power supplies 112-118 redundantly filter and condition the power for supply to the other electronic components. This construction greatly reduces the possibility of transient spike anomalies that could cause premature firings, distorted timing, over currents, over voltage or even avalanche breakdowns that could cause electronic components to fail.

The high voltage system (HVDC) 104 is preferably a plurality of batteries 130 and capacitors 132. In a most preferred embodiment the array of batteries 130 comprises ten 12V DC batteries 134 hooked up in series to provide a total of 120V DC power 136 to the electromagnetic coils. The array of capacitors 132 preferably comprises about twelve 10,000 Pico Farad capacitors 138. The capacitors are generally constructed and arranged to smooth the draw on the batteries to provide extended run times, reduce heat build-up in the batteries 134 and provide a smoother power signal to the coils. The positive polarity of the battery array 140 connects to the line side of a single pole single throw switch which acts as the main power switch 142 and can either energize or shut down all of the 120V DC supplied components throughout the HVDC system. From the load side of the main power switch 142, the 120 v DC positive polarity is divided into two separate HVDC supply legs 144, 146. A first leg 144 connects to the collector 149 of the first insulated gate bipolar transistor (IGBT) 148 supplying power to coil bank 1 150, including coils 1 and 4 156, 158, while the second leg 146 connects to the collector 151 of the second IGBT 152 supplying power to coil bank 2 154, including coils 2 and 3 160, 162.

In a preferred embodiment, the first and second IGBTs 148, 152 are MITSUBISHI part no. CM1200DC 34N and are each rated at 1,700 Volts 1,200 Amps. The first and second IGBTs 148, 152 are configured to include dual switching (two channels) capability and can be operated either independently, in tandem, or in an alternating pattern. When two IGBTs are utilized, Channel one 164, 166 respectively of each IGBT provides independent switching of the coil banks 1 & 2. It should also be noted that while the preferred embodiment includes two IGBTs, more or less IGBTs may be utilized without departing from the scope of the invention. From the Channel one 164 emitter of the first IGBT 148 the 120 v DC power passes through blocking diode 168; and from the Channel 1 166 emitter of the second IGBT 152 the 120 v DC power passes through a blocking diode 170. Diodes 168 and 170 are preferably power diodes, VISHAY part no. SDIIOOC16 B-PUK, rated at 1400 Amp 1600 Volts. Diode 168 is connected to coil bank 1 150, and diode 170 is connected to coil bank 2 154. Diodes 168 and 170 prevent any back EMF caused by a failure in fly-back diodes 172 or 174 from reaching the first or second IGBTs.

Still referring to FIGS. 4-10, the main components of the timing system 106 are two RT-610-10 U-shaped photoelectric infrared sensors 176, 178. The infra-red sensors 176, 178 cooperate with timing disc 181 (FIG. 1) to provide timing with respect to position of the crankshaft 20, and thus pistons 12 to initiate energizing coil bank one 150 or coil bank two 154 and when to shutdown/de-energize coil bank one and/or coil bank two. In this manner the infrared sensors operate to specify duration for independent operation of the coil banks. A low voltage ON or OFF digital signal regarding the specific duration is sent to a respective low voltage power modulator and pulse controller 180, 182. In operation, each photoelectric infrared sensor 176, 178 senses rotation of the timing disc 181 signaling the respective power modulator and pulse controller 180, 182 when to send power to a respective IGBT 148, 152 to energize a respective coil bank 150, 154. The signal is preferably a 12 v DC signal of a specific duration via an EMF shielded cable to the respective true bypass (TB) opto-coupler 184, 186. In a most preferred embodiment, one RT-610-10, one Power Modulator and Pulse Controller and one opto-coupler are provided for each bank of cylinders. Providing independent pulse width modulators (PWM) to TB opto-coupler groups for each coil bank isolates possibility of failures from cascading and increases options for function configurations of the coil banks. Each respective low voltage power modulator and pulse controller 180, 182 functions to interface the timing/firing system 100 with the fiber optically interfaced IGBTs 148, 152. The power modulator and pulse controllers 180, 182 also convert the steady on/off digital signal received from the timing/firing module 100 to a signal that can be manually varied in duty cycle within the signal time frame/duration sent. The purpose is to reduce heat produced by the DC high voltage/amperage supply 104 to the IGBT switching components and the electromagnetic coils in their respective coil bank, to be able to manually vary the revolutions per minute (RPMs) of the motor 10 by reducing the effective voltage supplied to the electromagnetic coils 22 in their respective coil bank and to bring efficiency to the collection of back EMF. This is accomplished via a Pulse Width Modulator within the power modulator and pulse controllers. In operation, when the TB Opto-coupler components 184, 186 receive the shielded 12 v DC ON digital signal from the RT-610-10 U-shaped photoelectric infrared sensor 176, 178 it closes an opto-isolating switch 188, 190. This action allows a pulse width modulated 5 v DC signal mirroring in duration the signal sent by the RT-610-10 photoelectric infrared sensor 176, 178, that is electrically isolated from the RT-610-10 in the Timing/Firing system 100. Opto-isolating is used to fire-wall one part of the system from another, preventing problems caused by cascading avalanche breakdown, induced EMF, spikes, and voltage clips. The pulse width modulated 5 v DC signal powers a fiber optic transmitter 192, 194 on the TB Opto-coupler, converting the signal from a pulsed width modulated electrical signal to pulsed width modulated laser light signal. The pulsed width modulated laser light ON or OFF digital signal is sent via a fiber optic cable 196, 198 to the fiber optically interfaced IGBT Driver 200, 202 which in turn will open or close the IGBT controlling the high voltage DC power. It should be appreciated that because fiber optics are immune to the high magnetic flux environment, converting the pulsed electrical signal to a laser pulsed signal maintains very low attenuation and high integrity of the signal to maintain the integrity of the signal to eliminate the need for EMF shielding and give greater latitude to the range of pulse width that can be utilized. Thus, much higher pulsing can be employed, allowing system design options regarding back EMF that are excluded by standard hard-wired IGBT drivers.

Referring to the firing system 100, the Fiber Optically Interfaced IGBT Driver 200,202 is constructed and arranged to control the opening and closing of the IGBT gates, thus switching on or off the HVDC power to the coil banks. Power supplied to the IGBT driver board 200, 202 is a filtered and conditioned 15 v DC 0.5 Amp. via shield twisted pair wires 124 extending from power supplies 112, 114. The IGBT Driver 200, 202 is also constructed and arranged to include features that can be incorporated as torque power output IC Controller/Sensors that allow the shift from a push-push system between the electromagnets and the permanent magnets to a system that pushes on one coil bank while the other coil bank pulls (attracts) thus adding more torque to the power stroke. Shifting from a push-push mode to a push-pull mode may be accomplished on the fly.

High voltage DC switching is accomplished by two high voltage, high amperage insulated gate bipolar transistors (IGBT) 148, 152 and are preferably HVIGBT MODULES MITSUBISHI part no. CM1200DC 34N, each rated at 1700 volts 1200 amps. Each IGBT is controlled by a driver board 200, 202 that is fiber optically interfaced to a respective TB opto-coupler component 184, 186 located in the low voltage power modulator and pulse controller. Each IGBT gates power to a respective coil bank or cylinder independently of other IGBTs being utilized. Each electromagnetic coil bank 150, 154 preferably include a flyback diode 204, 206 across its positive and negative connection. It has been found that VISHAY part no. SDI500030L B-PUK is rated at 1600 A 3000V diodes, and is suitable to eliminate flyback. Flyback is the sudden voltage spike seen across the inductive load presented by the coil banks when its supply voltage is abruptly changed by the systems pulsing and switching frequency. From each coil bank the high voltage DC continues through another isolation diode 208, 210, preferably VISHAY part no. SD1500030L B-PUK 1600 A 3000V. Isolation diodes 208, 210 are to be considered legacy components; their primary function is to isolate the magnetic coil banks from one another. Isolation diodes 208, 210 connect to a common copper buss 212 which connects to the negative terminal of the high voltage DC 120V Power Supply battery array.

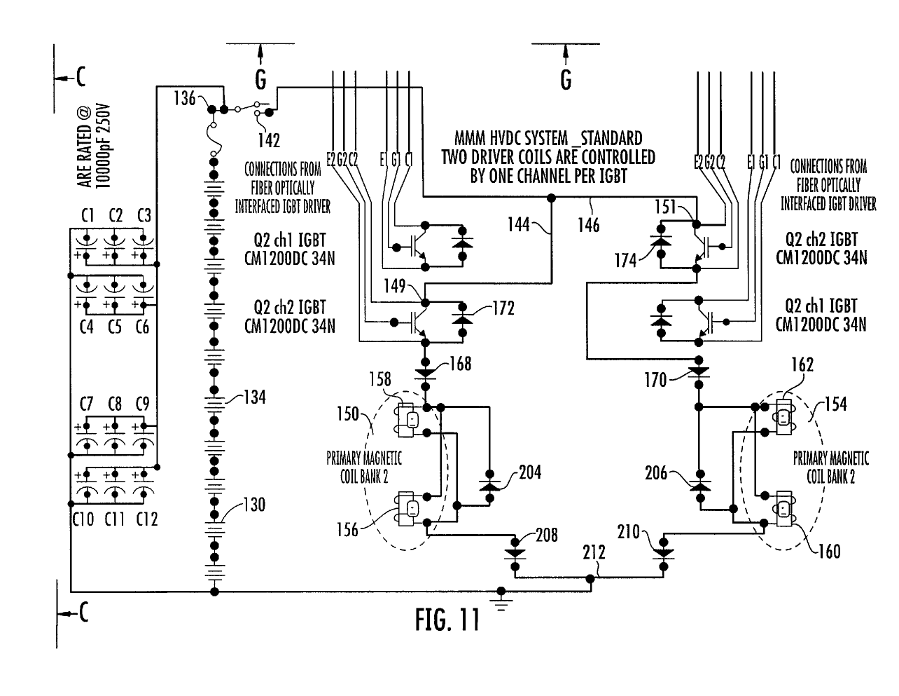

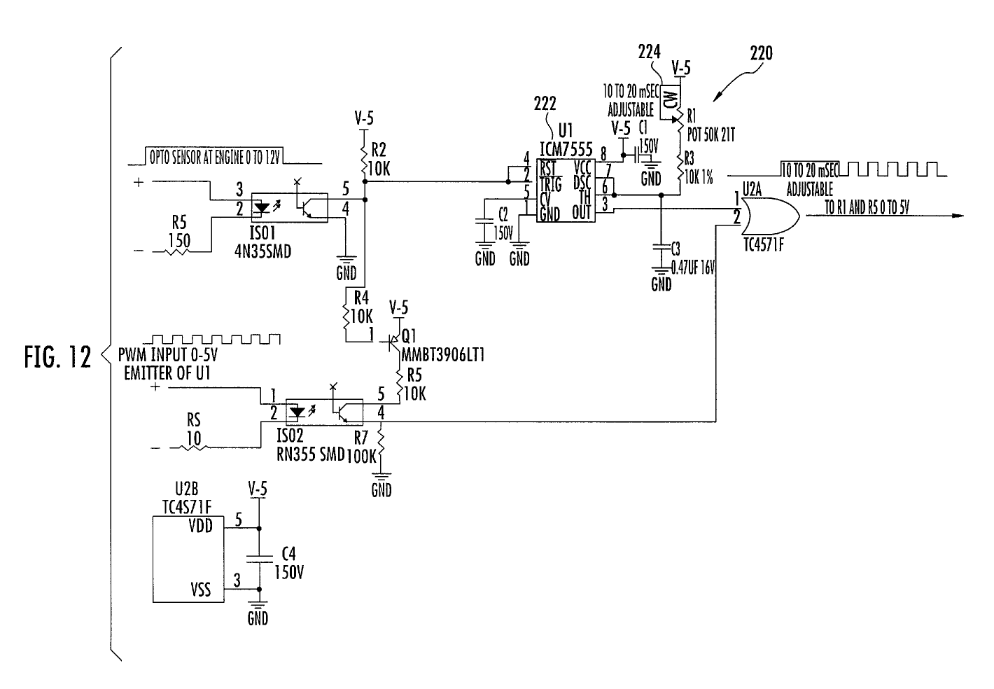

Referring to FIGS. 11 and 12, an alternative opto-isolator construction is illustrated. In this embodiment a timer circuit 222 and potentiometer 224 are included. With this arrangement, the firing window of the IGBTs can be broken into more than one pulse signal to allow additional control over the electromagnets and the power supply as illustrated in FIG. 12. This configuration allows an initial electrical impulse 226 followed by a second electrical pulse 228. Those skilled in the art will recognize that this construction allows the duty cycle of the electromagnets to be customized to a particular application. This construction also allows the duty cycle of the electromagnets to be altered based upon inputs from sensors, such as torque sensors, to reduce power consumption based on engine load. Other advantages include control over peak torque produced during the firing window which may include a lower duty cycle during the first portion of the firing window and a higher duty cycle during the second portion of the firing window.

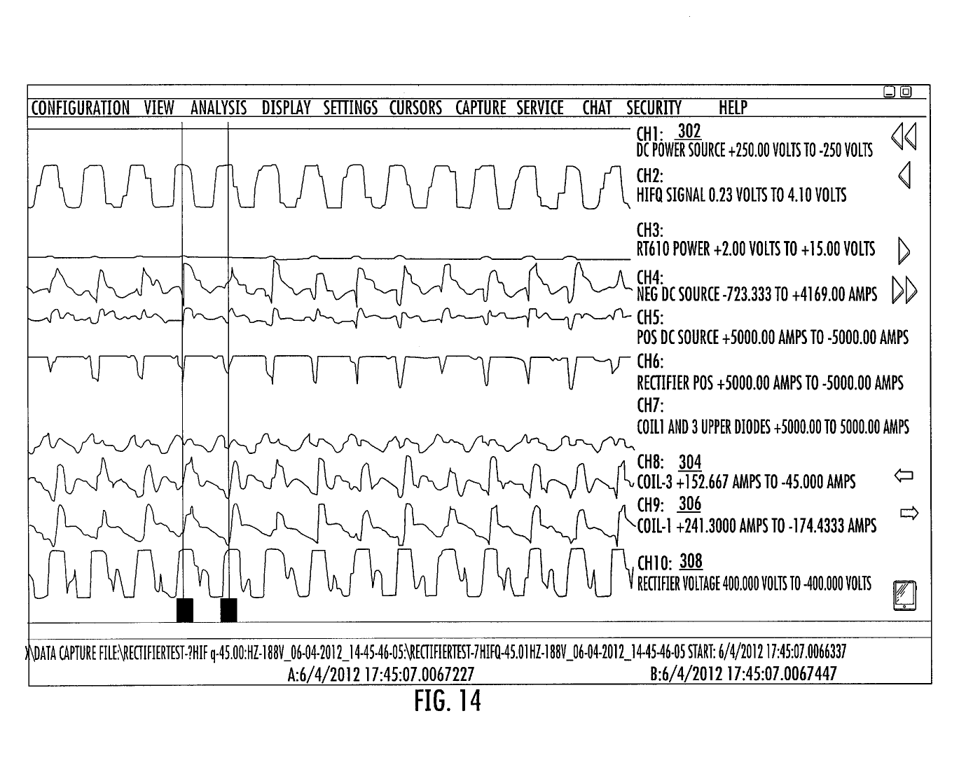

Referring to FIG. 14, a screen-print from a dynamometer test conducted on the system illustrated in FIG. 1 is illustrated. As illustrated at Channel one 302, the system was coupled to a 250 volt DC power source. It can also be seen at Channels 8 304 and channel nine 306 that the coils 1 and 3, as numbered on FIG. 1 were taking in about 200 amps during operation. It can also be seen that at channel ten the voltage coming out of the device was at 400 volts DC and at channel six 5000 amps were coming out of the device during operation. It should be noted that this test was re-conducted by an independent team at the University of Alabama where very similar results were recorded. As is best understood at this time, there are at least two scientific explanations for the results seen in the testing. The first explanation is back EMF which can be captured for re-use in the battery or diverted for work. The second is thermo-electric power capture as a result of electron spin-flip transition. It is believed that this system utilizes at least one and more likely utilizes both of the back EMF and thermo-electric power capture.

The present system comprises a highly polarized permanent magnet (PM) 16 adjacent to or in close proximity to a metallic magnon gain medium (MMGM), e.g. the core 24. The magnetic field imparted on the adjacent MMGM forms a localized spin accumulation, also known as a spin bias, or accumulation of non-equilibrium electrons. Since the spin accumulation in the MMGM is greatest in close proximity to the magnet, a spin diffusion gradient is formed through the length of the MMGM. Due to the elements present in the MMGM and the Fermi energies associated with the elements within the MMGM, the spin diffusion gradient sets up a preferred direction for the movement of magnon waves in the MMGM (magnon bias). The coil 28 that surrounds the MMGM is energized; preferably with DC square wave pulses from the firing system 100. The DC pulses provide an EMF in the direction of the interface between the PM and MMGM. Since the PM has already exerted a magnetic field great enough to spin polarize electrons in the nearby MMGM, equilibrium electrons (the ones that have not been spin biased) within this spin diffusion zone are already under EMF from the PM that brings them close to the spin-flip transition point (as described by the Zeeman Effect and Paschen Back Effect). The introduction of DC pulsed current at specific frequencies, voltages and currents provides the extra current needed to accomplish the spin-flip transition so that electron pairs in equilibrium (equal spin up and spin down) become non-equilibrium and become spin polarized for the duration of the square wave pulse. This is known as the spin-flip transition, and it takes place in the MMGM when the coil is energized. Magnon waves are already present due to the ambient heat in the atmosphere, the room or any location where the power generation apparatus resides. Therefore, magnon waves are present in the MMGM since it is at approximately the same temperature as the environment surrounding it. By nature, magnon waves are randomly oriented and cause random lattice vibrations between the atoms in any solid, including the MMGM. Magnon waves are present in any material that is warmer than absolute zero. When the coil around the MMGM turns on, inducing a magnetic field with sufficient intensity to exceed the localized Zeeman energy or “spin-flip transition energy” for equilibrium electrons in the metal atoms in the MMGM, electrons in these become spin biased and absorb a magnon to conserve energy during the spin flip. Therefore, with sufficient current delivered to the coil, the MMGM can saturate causing the maximum number of electrons to become spin biased and absorb magnons in the MMGM. As the square wave pulse falls to zero thus de-energizing the coil, normal spin relaxation occurs within the MMGM allowing substantially all of the magnons absorbed to be released at the same time, as a large percentage of the electrons in the MMGM flip back to their original spin orientation. Since all the magnons are dumped at once, they create an avalanche effect much like photons in a laser. When all of these magnons waves are released at the same time they are released toward the permanent magnet due to the polarization force of the magnet creating a spin bias or gradient in the MMGM, thus creating a preferred direction for the magnons to travel when they are released. As the magnons saturate or overload the MMGM with magnon waves in one direction, they collide with the end of the material at the point where the MMGM ends and the PM is positioned (known as the interface). The collapse of the magnetic field and the magnon bias direction is responsible for annihilating magnon waves through wave collision at the interface. When the magnon waves are destroyed, heat is destroyed making the temperature of the material drop. Since energy cannot be created or destroyed per the laws of thermodynamics, the ambient heat energy that caused the original randomly moving magnons in the MMGT core is converted back to a forceful spin wave in the MMGT “core”. This spin wave is propagated through the MMGT core as a strong electromagnetic pulse that can be collected via classical induction by the coil around the MMGT core. Once collected, the electrical power can be stored and applied to perform useful work.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device for producing electrical power comprising:
a permanent magnet having a pair of magnetic poles defining a longitudinal axis of said permanent magnet;
an electromagnet assembly having a pair of magnetic poles defining a longitudinal axis of said electromagnet;
a structure for securing and aligning said magnetic poles such that a distal end of said permanent magnet and said electromagnet assembly are in close proximity with respect to each other and such that said magnetic poles provide an opposing force with respect to each other;
a timing/firing system electrically connected to a source of electrical power and said electromagnet assembly for causing the electromagnet assembly to generate a magnetic field in a controlled manner which includes collapsing said magnetic field to generate an electrical pulse;
an output electrically connected to said electromagnet assembly for collecting and distributing said electrical pulse.

2. The device for producing electrical power of claim 1 including a device for oscillating one of said magnets in a controlled manner whereby the poles of the magnets interact with each other during said oscillations for increasing said electrical pulse.

3. The device for producing electrical power of claim 2 wherein said device for oscillating one of said magnets is a piezoelectric crystal.

4. The device for producing electrical power of claim 1 including a device for reciprocating one of said magnets along a substantially linear path in a controlled manner whereby the poles of the magnets interact with each other during said reciprocations for increasing said electrical pulse.

5. The device for producing electrical power of claim 4 wherein said device for reciprocating one of said magnets is a camshaft.

6. The device for producing electrical power of claim 4 wherein said device for reciprocating one of said magnets is a crankshaft.

7. The device for producing electrical power of claim 4 wherein said timing/firing system is utilized to monitor the position of said device for reciprocating one of said magnets for causing said electromagnet assembly to generate a magnetic field in response to the position of said permanent magnet with respect to said electromagnet assembly.

8. A process for producing electrical power comprising:
providing a permanent magnet, said permanent magnet having a pair of magnetic poles defining a longitudinal axis of said permanent magnet;
providing an electromagnet, said electromagnet having a pair of magnetic poles defining a longitudinal axis of said electromagnet;
providing a structure for securing and aligning said magnetic poles such that a distal end of said permanent magnet and said electromagnet are in close proximity with respect to each other and such that said magnetic poles provide an opposing force with respect to each other;
providing a timing/firing system electrically connected to a source of electrical power and said electromagnet for causing the electromagnet assembly to controllably generate a magnetic field in a controlled manner which includes collapsing said magnetic field to generate an electrical pulse;
providing an output electrically connected to said electromagnet for collecting and distributing said electrical pulse.

9. The process for producing electrical power of claim 8 including providing a device for oscillating one of said magnets in a controlled manner whereby the poles of the magnets interact with each other during said oscillations for increasing said electrical pulse.

10. The process for producing electrical power of claim 8 including providing a device for reciprocating one of said magnets along a substantially linear path in a controlled manner whereby the poles of the magnets interact with each other during said reciprocations for increasing said electrical pulse.

11. The process for producing electrical power of claim 10 wherein said device for reciprocating one of said magnets is a camshaft.

12. The device for producing electrical power of claim 10 wherein said device for reciprocating one of said magnets is a crankshaft.

13. The device for producing electrical power of claim 10 wherein said timing/firing system is utilized to monitor the position of said device for reciprocating one of said magnets for causing said electromagnet assembly to generate a magnetic field in response to the position of said permanent magnet with respect to said electromagnet assembly.

14. A device for producing electrical power comprising any feature described, either individually or in any combination with any feature, in any configuration.

15. A method for producing electrical power comprising any process described, in any order, using any modality, either individually or in combination with any feature, in any configuration.
